(19) United States
(12) Patent Application Publication
(10) Pub. No.: US 2009/0200237 A1
(43) Pub. Date: Aug. 13, 2009

(54) ENERGY SAVING SPIRAL ELEMENT

(76) Inventors: David B. Weber, Maple Grove, MN (US); Kevin J. Knebel, Simi Valley, CA (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/299,328

(22) PCT Filed: May 2, 2007
(86) PCT No.: PCT/US07/68028

§ 371 Date: Nov. 3, 2008

Related U.S. Application Data
(60) Provisional application No. 60/746,236, filed on May 2, 2006.

(51) Int. Cl. B01D 63/10; B01D 65/00; B01D 61/00

(52) U.S. Cl. 210/650; 210/494.1; 210/321.83

(57) ABSTRACT

A filter media, in particular a separation module, characterized by a flow control strip (40) circumferentially surrounding the media at one end of the filter media, in particular a spiral wound membrane material, which strip extends only a relatively short distance (D) along the length of the filter media. The strip preferably is an open mesh material that cooperates with an overlapping portion of an open mesh net that surrounds the filter media over essentially the entire axial length of the media, to provide for controlled bypass flow through the overlapped strip and net while still enabling easy assembly of the filter media and surrounding net into a housing. The strip of material allows the filter media, such as a spiral wound membrane module, to be “sized” at one end of the membrane module for creating a compressible area that restricts bypass flow while allowing for easy installation and removal of the membrane module.

### RELATED APPLICATIONS

This application claims the benefit of U.S. Provisional Application No. 60/746,236 filed May 2, 2006, which is hereby incorporated by reference.

### FIELD OF THE INVENTION

The herein described invention relates generally to separation devices used for ultrafiltration, microfiltration, nanofiltration, and reverse osmosis. More particularly, the invention relates to spiral wound membrane separation devices that provide partial but controlled bypass flow that prevents fluid stagnation within and around the spiral wound membrane module during use.

### BACKGROUND OF THE INVENTION

In a typical spiral wound membrane separation device, also commonly referred to as a spiral wound membrane filter, module or cartridge, one or more membrane sheets is wound around a porous tube and disposed within a housing. A feed fluid enters at one end of the housing and travels through feed spacers positioned parallel to and between the wound layers of the membrane sheet or sheets. Separation occurs at the membrane-fluid interface, with part of the fluid, called the permeate, passing through the membrane layer while the rest of the mixture remains on the opposite side of the membrane as more highly concentrated feed. The permeate stream travels in an inwardly spiraling radial direction until it passes through the wall of the central tube for recovery from one or both ends of the central tube.

Attempts to provide for the cleaning and sanitizing of the annular space between the exterior of the spiral-wound membrane and the housing have included the use of a so-called “leaky brine seal”, as described in U.S. Pat. No. 4,064,052. According to this patent, one or more small holes are placed in an annular lip seal within the annular space between the spiral-wound membrane and the interior wall of the housing. The holes in the lip seal permit a small controlled flow of the feed stream to bypass the module continually through the annular space and prevent any stagnation or accumulation of product or residue behind the seal. This approach, however, is not wholly satisfactory and has various manufacturing cost and operational difficulties associated with its practice.

U.S. Pat. No. 4,301,013 discloses the use of a tight fitting open mesh within the annular space to control the bypass flow. A disadvantage of this controlled by-pass design is that in most cases a substantial proportion of the feed flow will by-pass the filtration membrane, resulting in wasted pump energy and reduced operating efficiency. This occurs because there is a practical difficulty in controlling the cartridge outer diameter and housing internal diameter to the extent required to prevent a loose cartridge fit and preferential feed flow through the resultant gap.

### SUMMARY OF THE INVENTION

The present invention provides a filter media, in particular a separation module, characterized by a flow control strip circumferentially surrounding the media at one end of the filter media, in particular a spiral wound membrane material, which strip extends only a relatively short distance along the length of the filter media. The strip preferably is an open mesh material that cooperates with an overlapping portion of an open mesh net that surrounds the filter media over essentially the entire axial length of the media, to provide for controlled bypass flow through the overlapped strip and net while still enabling easy assembly of the filter media and surrounding net into a housing. The strip of material allows the filter media, such as a spiral wound membrane module, to be “sized” at one end of the membrane module for creating a compressible (or more compressible) area that restricts bypass flow while allowing for easy installation and removal of the membrane module.

Accordingly, a filter element comprising a central perforated support core, filter media wound around the support core, the filter media comprising laterally-extending (i.e. along the axis of the filter media) channels, where the media has an efficiency sufficient to allow a permeate in a fluid flow to pass radially inward through the media and into the perforated center tube, and a media strip applied toward one end of the wound media and circumferentially surrounding the media only toward the one end.

The filter element, when disposed in a cylindrical internal chamber of a housing, allows a predetermined bypass fluid path between an outer surface of the media and the surrounding housing.

One or more embodiments according to the invention may have one or more of the following additional features.

The filter media may include a membrane through which a permeate can pass from the laterally extending channels.

The filter media may be surrounded at its outer diameter by an open-mesh net that will be located in an annular clearance space between the membrane module and the housing when the filter media is disposed in the housing.

The media strip may be an open mesh material.

The media strip may be located between the filter media and the net.

The strip normally will be provided at the upstream end of the membrane module.

The strip may have a circumferential length of about the same to about 1.75 the circumference of the membrane module at the end thereof circumscribed by the strip.

The strip may be sandwiched between the membrane module and netting that surrounds the membrane along the axial length of the membrane module.

The strip may be an open mesh type material made of a synthetic or polymeric material.

The strip may be formed of the same material as the net.

The strip and net may have circumferential ribs that face one another in overlapping and/or alternating relationship to hold the strip in place.

The strip may have an axial length of about ⅜ inch to about 1.5 inch.

The strip may have an axial length of no more than 20% of the overall axial length of the filter media.

According to another but related aspect of the invention, a method of controlling bypass flow along a filter element in a housing comprises the step of applying a media strip toward one end of the wound media such that it circumferentially surrounds the media only toward the one end, and then inserting the filter media, net and media strip in the housing with the media strip and net being compressed between the filter media and housing to a greater extent than the balance of the filter media beyond the media strip.

Further features of the invention will become apparent from the following detailed description when considered in conjunction with the drawings.

### BRIEF DESCRIPTION OF DRAWINGS

In the annexed drawings:

FIG. 1 is a schematic cross-sectional view of a prior art separation device, showing a spiral-wound membrane within a housing;

FIG. 2 is a fragmentary enlarged cross-sectional view of the separation device of FIG. 1, taken along the line 2-2 of FIG. 1;

FIG. 3 is a fragmentary cross-sectional view of an exemplary separation device according to the invention;

FIG. 4 is a cross-sectional view of the separation device of FIG. 3, taken along the line 4-4 of FIG. 3;

FIG. 5 is an enlarged edge portion of FIG. 3; and

FIG. 6 is a schematic illustration of an exemplary method of making the separation device in accordance with the invention.

### DETAILED DESCRIPTION

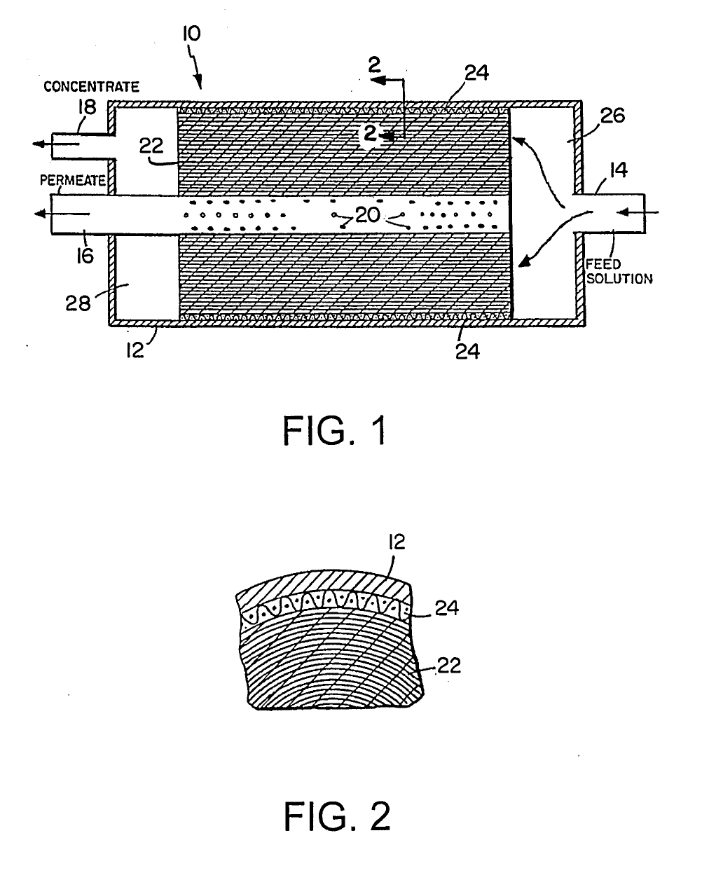

Referring now to the drawings in detail and initially to FIGS. 1-3, a prior art separation device of the type disclosed in U.S. Pat. No. 4,301,013 is designated generally by reference number 10. The separation device comprises a housing 12 in which a spiral-wound membrane module 22 is disposed. The housing has an inlet 14 for the introduction of a feed fluid, a supply chamber 26 at one end of the spiral wound membrane module, a collection chamber 28 at the other end of the spiral wound membrane module, and an outlet 18. The spiral wound membrane module is formed by winding one or more membrane sheets around a foraminous center tube 20 provided with an outlet 16 for permeate that is collected in the center tube. The spiral-wound membrane sheet has a membrane, a permeate-collector sheet and a spacer.

In operation, a feed solution is introduced through inlet 14 and into space 26, where it flows axially through axially extending channels (also herein referred to as laterally extending channels) in the spiral-wound membrane module 22. Separation occurs at the membrane-fluid interface, with part of the fluid, called the permeate, passing through the membrane layer while the rest of the mixture remains on the opposite side of the membrane as more highly concentrated feed. The permeate stream travels in an inwardly spiraling radial direction until it passes through the wall of the central tube for recovery via the outlet 16. The more highly concentrated feed passes out of the housing via the outlet 18.

The radially outer surface of the spiral-wound membrane module is surrounded by an open-mesh net (netting) 24 that consequently is located in an annular clearance space between the membrane module and the housing. The open-mesh net may be an extruded-strand, open-mesh material made of polyethylene or polypropylene. The net is positioned as a single wrap extending along the axial length of the membrane module. The open-mesh material 24 provides for by-pass of the feed solution through the open-mesh material to prevent the buildup of stagnation products. The tubular, single-layer mesh material may be immersed in a hot-water bath and slid about the exterior surface of the membrane module in a softened state.

As indicated, the netting may be an open mesh type material composed of a synthetic or polymeric material. The netting may be woven or nonwoven and of varying thickness and patterns. The material for constructing the netting should be nonreactive with the fluid being processed. Those skilled in the art will appreciate that other types of netting could be substituted for outer wrap 24 without departing from the scope of the present invention.

A problem with the foregoing prior art design is that in order to reduce the bypass flow to make the separation device more energy efficient, close tolerances are needed between the outer diameter surface of the spiral-wound membrane module, net 24 and inner diameter surface of the housing 12. Even if such close tolerances could be economically provided, a too tight fit between the net and the housing can make it difficult to assemble the membrane module in the housing.

The present invention solves the aforesaid problem by providing a flow restricting strip 40 of material (herein also referred to as a media strip), preferably a porous material, at one end of the membrane module 22. The strip of material, that extends only a relatively short distance “D” along the axial length of the membrane module, allows the spiral wound membrane module to be “sized” at one end of the membrane module for creating a compressible area that restricts bypass flow while allowing for easy installation and removal of the membrane module.

The strip 40 normally will be provided at the upstream end of the membrane module 22, although it may be optionally provided elsewhere along the length of the module.

The strip 40 normally will be provided on the end of the module opposite the end that is first inserted into the housing during assembly of the module in the housing 12. This will avoid problems such as telescoping of the module during assembly since the leading portion of the module will relatively easily slip into the housing while the trailing portion with the strip will encounter relatively increased resistance as the strip and netting are radially compressed between the module and the housing.

The length of the strip 40 may be varied to provide a desired size and in turn a desired fit within the housing. The strip may have a circumferential length of about the same to about 1.75, and more particularly about 1.25 to about 1.5, the circumference of the membrane module at the end thereof circumscribed by the strip. It is noted that the net typically is wrapped around the membrane module about 1.25 to 1.5 times, and the strip likewise can be wrapped around the membrane module by a corresponding amount preferably with the overlapped portion of the strip (that is, the portion of the strip that is overlapped on another portion of the strip) circumferentially offset from the overlapped portion of the net.

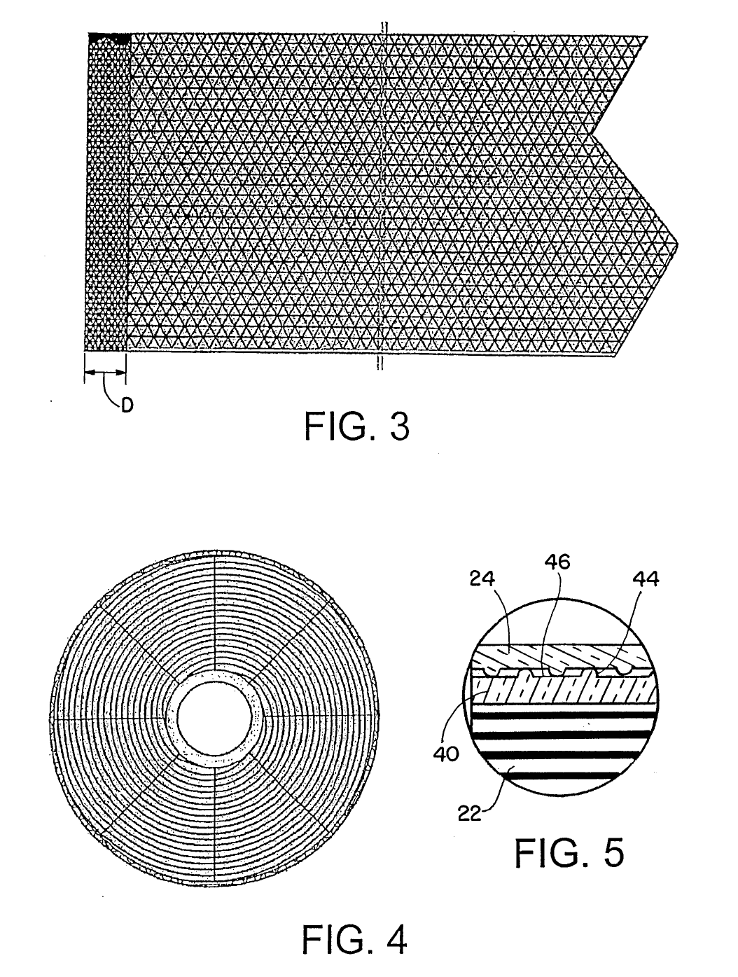

As seen in FIG. 3, the strip 40 may be sandwiched between the membrane module 22 and netting 24 that surrounds the membrane along the axial length of the membrane module, although the strip may be disposed, as by wrapping, around the netting.

The strip 40 may be an open mesh type material made of a synthetic or polymeric material, and such materials are known in the art.

The strip 40 may be formed of the same material as the netting 24. In particular, both the netting and strip may be an extruded, open-mesh material made of polyethylene or polypropylene.

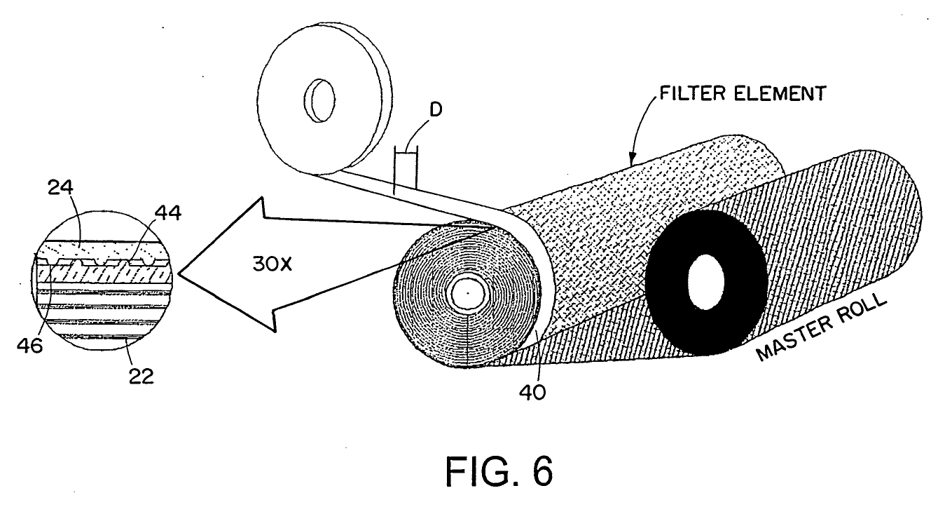

The strip 40 may be relatively inverted so that circumferential ribs (depicted at 44 and 46 in FIGS. 5 and 6) on the netting and the strip face one another preferably in overlapping and/or alternating relationship as depicted in FIG. 4, whereby the strip can be held in place.

The strip 40 may have an axial length of about ⅜ inch to about 1.5 inch, and more particularly about one half to three quarter inch.

More generally, the strip 40 may have an axial length of no more than 20% of the overall axial length of the membrane module 22, more particularly no more than 10%, and still more particularly no more than 5%.

The axial length should be sufficient to provide a controlled bypass flow through the strip and netting, while still allowing for insertion of the now radially enlarged end portion of the module into the housing.

The housing 12 may have an axial length for accommodating a plurality of membrane modules in end-to-end relationship, as is conventionally known in the art. Each module may be provided with a flow restricting strip as above described.

FIG. 6 depicts a method of applying the flow restricting strip 40 and netting to the membrane module.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A filter element comprising a central perforated support core, filter media wound around the support core, the filter media comprising laterally-extending channels, where the media has an efficiency sufficient to allow a permeate in a fluid flow to pass radially inward through the media and into the perforated center tube, and a media strip applied toward one end of the wound media and circumferentially surrounding the media only toward the one end, the media strip, when assembled into a housing, allowing a predetermined bypass fluid path between an outer surface of the media and a surrounding housing.

2. A filter assembly comprising a housing with a cylindrical internal chamber, and the filter element of claim 1, disposed within the chamber, wherein the media strip allows a predetermined bypass fluid path between an outer surface of the media and the surrounding housing.

3. The filter element or filter assembly of claim 1, wherein the filter media includes a membrane through which a permeate can pass from the laterally extending channels.

4. The filter element or filter assembly of claim 1, wherein filter media is surrounded at its outer diameter by an open-mesh net that will be located in an annular clearance space between the membrane module and the housing when the filter media is disposed in the housing.

5. The filter element or filter assembly of claim 1, wherein the media strip is an open mesh material.

6. The filter element or filter assembly of claim 4, wherein the media strip is located between the filter media and the net.

7. The filter element or filter assembly of claim 1, wherein the strip normally will be provided at the upstream end of the membrane module, although it may be optionally provided elsewhere along the length of the module.

8. The filter element or filter assembly of claim 1, wherein the strip has a circumferential length of about the same to about 1.75 the circumference of the membrane module at the end thereof circumscribed by the strip.

9. The filter element or filter assembly of claim 4, wherein the strip is sandwiched between the membrane module and netting that surrounds the membrane along the axial length of the membrane module.

10. The filter element or filter assembly of claim 1, wherein the strip is an open mesh type material made of a synthetic or polymeric material.

11. The filter element or filter assembly of claim 4, wherein the strip is formed of the same material as the net.

12. The filter element or filter assembly of claim 1, wherein the strip and net have ribs that face one another in overlapping and/or alternating relationship to hold the strip in place.

13. The filter element or filter assembly of claim 1, wherein the strip has an axial length of about ⅜ inch to about 1.5 inch.

14. The filter element or filter assembly of claim 1, wherein the strip has an axial length of no more than 20% of the overall axial length of the filter media.

15. A method of controlling bypass flow along a filter element in a housing, wherein the filter element includes a central perforated support core, filter media wound around the support core, the filter media comprising laterally-extending channels, where the media has an efficiency sufficient to allow a permeate in a fluid flow to pass radially inward through the media and into the perforated center tube, and a net surrounding the filter media, the method comprising the step of applying a media strip toward one end of the wound media such that it circumferentially surrounds the media only toward the one end, and then inserting the filter media, net and media strip in the housing with the media strip and net underlying the media strip being compressed between the filter media and housing to a greater extent than the balance of the net and filter media beyond the media strip, the media strip allowing a predetermined bypass fluid path between an outer surface of the media and the surrounding housing.
